(19) United States
(12) Patent Application Publication
(10) Pub. No.: US 2003/0158739 A1
(43) Pub. Date: Aug. 21, 2003

(54) Speech navigation of voice mail systems

(76) Inventors: Peter A. Moody, Fishers, IN (US); Mark A. Cummings-Hill, Carmel, IN (US)

Correspondence Address: STEFAN V. CHMIELEWSKI, DELPHI TECHNOLOGIES, INC., Legal Staff Mail Code A-107, P.O. Box 9005, Kokomo, IN, 46904-9005, US

(21) Appl. No.: 10/075,980

(22) Filed: Feb. 15, 2002

(51) Int. Cl. G10L 21/00

(52) U.S. Cl. 704/275

(57) ABSTRACT

A speech navigation system provides for speech navigation of a voice mail system. Upon establishment of a communication link between the speech navigation system and the voice mail system, the speech navigation system may receive a voice command. Upon receiving a voice command, the speech navigation system associates the voice command to at least one keypad character. The speech navigation system then provides a telephone dialing tone, which corresponds to the at least one associated keypad character, to the voice mail system.

### TECHNICAL FIELD

The present invention is generally directed to speech recognition and, more specifically, to speech navigation of voice mail systems.

### BACKGROUND OF THE INVENTION

As is well known to one of ordinary skill in the art, speech recognition is a field in computer science that deals with designing computer systems that can recognize spoken words. A number of speech recognition systems are currently available (e.g., products are offered by IBM, Lernout & Hauspie and Philips). Traditionally, speech recognition systems have only been used in a few specialized situations due to their cost and limited functionality. For example, such systems have been implemented when a user was unable to use a keyboard to enter data because the user's hands were disabled. Instead of typing commands, the user spoke into a microphone. However, as the cost of these systems has continued to decrease and the performance of these systems has continued to increase, speech recognition systems are being used in a wider variety of applications (as an alternative to keyboards or other user interfaces). For example, speech actuated control systems have been implemented in motor vehicles to control various accessories within the motor vehicles.

A typical speech recognition system, that is implemented in a motor vehicle, includes voice processing circuitry and memory for storing data representing command words (that are employed to control various vehicle accessories), which, in general, have been predefined. In a typical system, a microprocessor is utilized to compare user provided data (i.e., voice input) to stored speech models to determine if a word match has occurred and provide a corresponding control output signal in such an event. In addition, the microprocessor has also normally controlled a plurality of motor vehicle accessories, e.g., a cellular telephone and a radio. Such systems have advantageously allowed a driver of the motor vehicle to maintain vigilance while driving the vehicle.

However, while proposed speech recognition systems, located within a motor vehicle, have provided a voice activated communication link via a cellular telephone located within the vehicle, such systems have not been capable of interacting with voice mail systems. In general, voice mail systems have utilized dual tone multiple frequency (DTMF) signals, which are generated when, for example, a user presses an appropriate keypad on a touch-tone telephone, as commands for the voice mail systems. For example, upon entry into a voice mailbox of a voice mail system, a user may retrieve mail messages by pressing the number 7 on a touch-tone telephone keypad. While accessing a typical voice mail system has not posed a problem for a typical stationary user, using such a voice mail system can lead to various safety concerns when a given user is mobile, e.g., traveling in a motor vehicle.

Thus, what is needed is a speech navigation system that provides for voice control of a voice mail system. Further, it would be desirable for the speech navigation system to communicate with multiple voice mail systems that implement different dual tone multiple frequency (DTMF) tones for a given function.

### SUMMARY OF THE INVENTION

An embodiment of the present invention is directed to a speech recognition system for providing speech navigation of a voice mail system. Upon establishment of a communication link between a speech navigation system and a voice mail system, the speech navigation system may receive a voice command. Upon receiving the voice command, the speech navigation system associates the voice command to at least one keypad character. The speech navigation system then provides a telephone dialing tone, which corresponds to the associated at least one keypad character, to the voice mail system. In one embodiment, the telephone dialing tone is a dual tone multiple frequency (DTMF) tone. In another embodiment, the keypad character is one of a 0, 1, 2, 3, 4, 5, 6, 7, 8, 9, * and #.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of an exemplary speech recognition system, implemented within a motor vehicle, that is in communication with an external voice mail system, according to an embodiment of the present invention;

Fig. 2 is a flow diagram of an exemplary routine executing on an external computer system for associating dual tone multiple frequency (DTMF) tones with a keypad character and a voice command, according to an embodiment of the present invention; and

FIG. 3 is a flow diagram of an exemplary routine for providing a telephone dialing tone from a speech navigation system to a voice mail system, according to an embodiment of the present invention.

### DESCRIPTION OF THE PREFERRED EMBODIMENT(S)

According to the present invention, a voice mail system is navigated through speech. Initially, a communication link is established between a speech navigation system and a voice mail system. In one embodiment, upon receiving a mode control signal, the speech navigation system transitions from a voice mode to a speech recognition mode while maintaining the communication link between the speech navigation system and the voice mail system. Upon receiving a voice command from a user, the speech navigation system associates the voice command with a keypad character or characters and provides a telephone dial tone, which corresponds to the associated keypad character or characters, to the voice mail system.

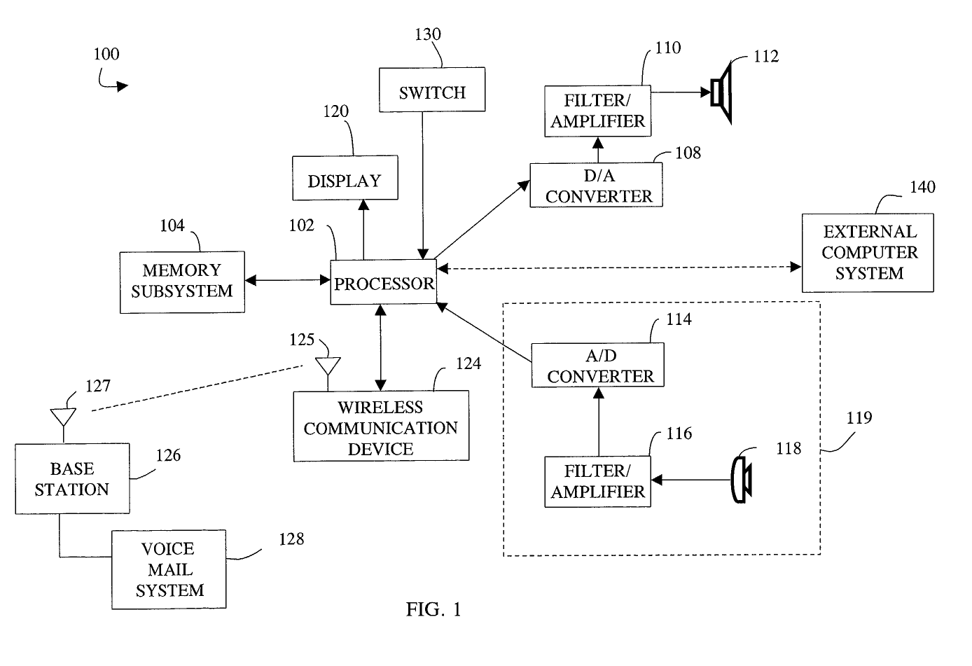

FIG. 1 depicts a block diagram of an exemplary speech navigation system 100, that may be implemented within a motor vehicle (not shown), that communicates with a voice mail system 128 (via a base station 126 and an associated antenna 127) via dual tone multiple frequency (DTMF) tones, according to an embodiment of the present invention. As shown, the system 100 includes a processor 102 coupled to a wireless communication device (e.g., mobile or cellular telephone) 124 and a display 120. The processor 102 may control the wireless communication device 124, at least in part, as dictated by voice input supplied by a user of the system 100.

The processor 102 may also supply various information to a user, via the display 120 and/or the speaker 112, to allow the user of the motor vehicle to better utilize the system 100. In this context, the term processor may include a general purpose processor, a microcontroller (i.e., an execution unit with memory, etc., integrated within a single integrated circuit) or a digital signal processor (DSP). The processor 102 is also coupled to a memory subsystem 104, which includes an application appropriate amount of main memory (e.g., volatile and non-volatile memory), which provides a storage area for one or more speech recognition applications and one or more voice mail system profiles. The profiles are files that associate a plurality of voice commands to one of a plurality of keypad characters.

The following text sets forth an exemplary dialog with a user of a typical voice mail system after a communication link has been established, when no messages are in the voice mailbox. The dialog, set forth below, illustrates the tree structure of a typical voice mail system menu with user entries bracketed (< >).

Thanks for calling the Offices of ABC Company;

Please enter a mailbox number;

<#123>

Hello, John Smith;

Please enter your passcode;

<321>

You have no new messages;

You have no messages in your mailbox;

To make a new message, press 6; to change user options, press 8; to reach another mailbox, press 0; to exit the system press 9;

<8>

User Options; To change your mailbox setup, press 1; to change a distribution list, press 2; to return to the previous menu, press 9.

<9>

To make a new message, press 6; to change user options, press 8; to reach another mailbox, press 0; to exit the system press 9;

<9>

Thank you for calling. Goodbye.

From the above dialog, it should be apparent that a user of a voice mail system has navigated the voice mail system by pressing appropriate alphanumeric keypad characters (e.g., 0, 1, 2, 3, 4, 5, 6, 7, 8, 9, *, #), typically located on a telephone keypad. It should be appreciated that the same keypad character may cause a different function to be performed by different voice mail systems. For example, the keypad character ‘7’ may cause one voice mail system to retrieve a saved message and another voice mail system to exit a given branch of the voice mail system.

As is also shown in FIG. 1, an audio input device 118 (e.g., a microphone) is coupled to a filter/amplifier module 116. The filter/amplifier module 116 filters and amplifies the voice input provided by a user through the audio input device 118. The filter/amplifier module 116 is also coupled to an analog-to-digital (A/D) converter 114, which digitizes the voice input from the user and supplies the digitized voice to the processor 102 which, in turn, executes a speech recognition application, which causes the voice input to be compared to system recognized commands. In general, the audio input device 118, the filter/amplifier module 116 and the A/D converter 114 form a voice input circuit 119.

The processor 102 may execute various routines in determining whether the voice input corresponds to a system recognized command. According to the present invention, the processor 102 provides a signal, which corresponds to the recognized command, to the wireless communication device 124 which, in response thereto, provides an appropriate dual tone multiple frequency (DTMF) tone to the voice message system 128, via the base station 126 (including the antenna 127). The processor 102 may also cause an appropriate voice output to be provided to the user through an audio output device 112. The synthesized voice output is provided by the processor 102 to a digital-to-analog (D/A) converter 108. The D/A converter 108 is coupled to a filter/amplifier section 110, which amplifies and filters the analog voice output. The amplified and filtered voice output is then provided to audio output device 112 (e.g., a speaker).

As is further described below, the processor 102 is also coupled to an external computer system 140, which allows a user to associate a given voice command with a particular keypad character.

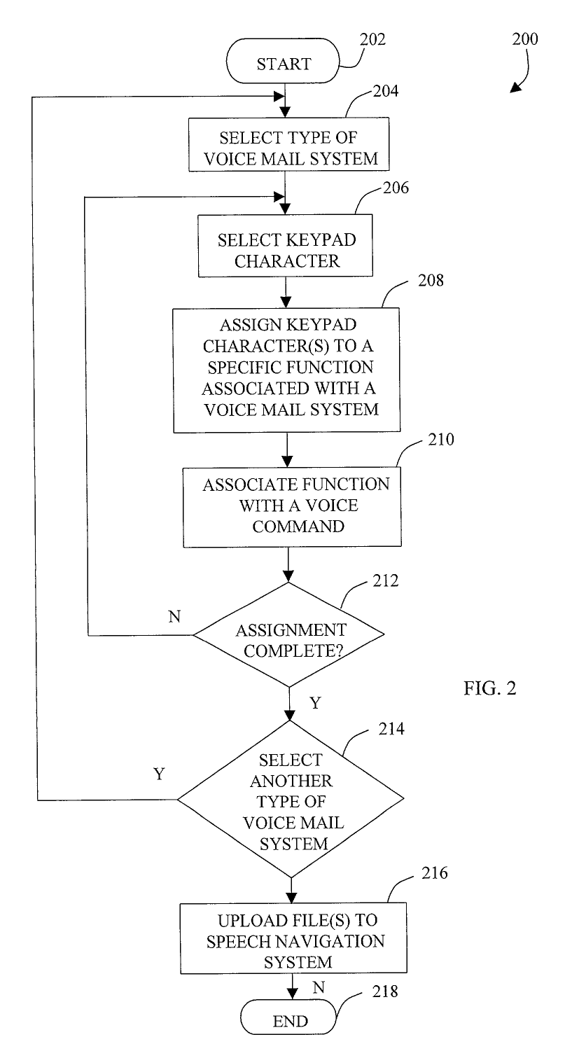

FIG. 2 illustrates an exemplary flow diagram of a routine 200, which associates dual tone multiple frequency (DTMF) tones with a keypad character and a voice command, according to one embodiment of the present invention. In one embodiment, the routine 200 is implemented on the external computer system 140, which may be of various types, such as a personal digital assistant (PDA), a mobile multi-media head unit, a mobile phone display, etc. Alternatively, the routine 200 may be implemented by a voice system of the speech navigation system 100 or other device. When the routine 200 is implemented on the computer system 140, the routine 200 preferably provides setup pages such that a user of the system 140 can assign keypad characters to a function (e.g., skip, next, previous, delete, etc.) specific to a given voice mail system. In one embodiment, the setup pages provide a list of standard functions, as well as mailbox and passcode fields with corresponding entry blanks, which allow a user to assign voice mail system key presses to a listed function.

In step 202, the routine 200 is initiated at which point control transfers to step 204. In step 204, the routine 200 allows the user to select a type of voice mail system. Next, in step 206, the routine 200 allows the user to select a keypad character 206. Then, in step 208, the routine 200 allows the user to assign keypad characters to a specific function associated with the selected voice mail system. Next, in step 210, the routine 200 associates the function with a voice command. Then, in decision step 212, the routine 200 determines whether the assignment is complete. If so, control transfers from step 212 to decision step 214. Otherwise, control transfers from step 212 to step 206 where a user can select another keypad character or modify an existing assignment. In step 212, when the user has indicated that the assignment is complete, the routine 200 determines whether a user desires to select another type of voice mail system for which to assign keypad characters to voice mail system functions and voice commands. If so, control transfers from step 214 to step 204. Otherwise, control transfers to step 216 where a file or files containing the keypad character/voice command associations are uploaded to the memory subsystem 104, via the processor 102.

It should be appreciated that the specific function to be performed in a voice mail system may be the same as an assigned voice command and in this situation, step 210 would not need to be performed. However, if a user wishes to use a different term for a specific function in a voice mail system, step 210 is implemented to associate a function of the voice mail system with a desired voice command. Upon completion of the upload from the external computer system 140 to the system 100, the routine terminates at step 218, at which point a user may disconnect the system 140 from the system 100. Alternatively, the system 140 may communicate with the system 100, via a wireless communication link.

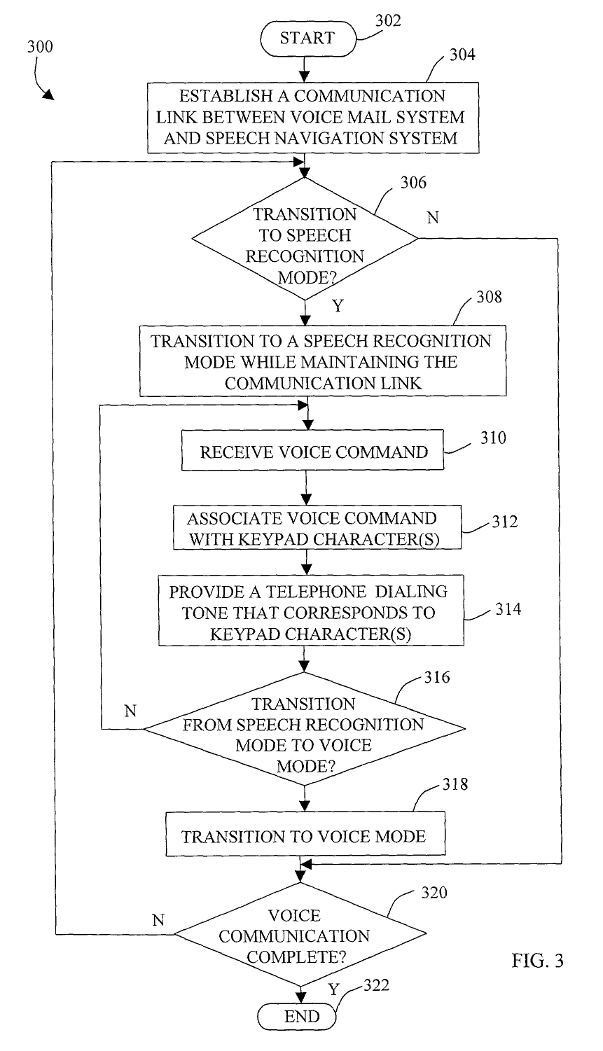

FIG. 3 depicts an exemplary flow diagram of a routine 300 for providing a telephone dialing tone from the speech navigation system 100 to the voice mail system 128, according to an embodiment of the present invention. In step 302, the routine 300 is initiated at which point control transfers to step 304. In step 304, the processor 102, implementing the routine 300, establishes a communication link between the voice mail system 128 and the speech navigation system 100. Next, in decision step 306, the processor 102 determines whether to transition to a speech recognition mode. It should be appreciated that the transition to the speech recognition mode may be initiated when a user actuates an external switch 130 (e.g., a barge or “press-to-talk” button) or may be initiated through, for example, a particular voice command (e.g., a keyword command) that would not normally be used in voice mode communications.

When the processor 102 determines that a transition to the speech recognition mode should occur, control transfers from step 306 to step 308. Otherwise, control transfers from step 306 to decision step 320. In step 308, the processor 102 transitions to the speech recognition mode while maintaining the communication link between the voice mail system 128 and the speech navigation system 100. Next, in step 310, the processor 102 receives a voice command from a user, at which point control transfers to step 312. In step 312, the processor 102 associates the voice command with a keypad character through the use of the one or more profile files. Next, in step 314, the processor 102 causes a telephone dialing tone, which corresponds to the associated keypad character, to be provided by the wireless communication device 124. Then, in decision step 316, the processor 102 determines whether it should transition from the speech recognition mode to a voice mode. If so, control transfers from step 316 to step 318 where the processor 102 transitions to a voice mode. Otherwise, control transfers from step 316 to step 310. After transitioning to the voice mode in step 318, the processor 102 determines whether voice communication is complete in step 320. The completion of voice communication may be indicated by a specific voice command and/or an input provided to the processor 102 via, for example, an external switch activation. If voice communication is not complete in step 320, control transfers to step 306 and the processor 102 once again determines whether it should transition to the speech recognition mode. In step 320, when the processor 102 determines voice communication is complete, control transfers to step 322 where the routine 300 terminates.

Accordingly, an automotive speech navigation system has been described that provides DTMF signals to a voice message system. The speech navigation system advantageously allows a user to retrieve, forward, etc., voice messages associated with a voice mail system in an essentially hand-free manner.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

1. A method for providing speech navigation of a voice mail system, comprising the steps of:
establishing a communication link between a speech navigation system and a voice mail system;
providing a voice command to the speech navigation system, wherein the voice command has at least one associated keypad character; and
providing a telephone dialing tone from the speech navigation system to the voice mail system, wherein the telephone dialing tone corresponds to the at least one associated keypad character of the voice command.

2. The method of claim 1, wherein the telephone dialing tone is a dual tone multiple frequency (DTMF) tone.

3. The method of claim 1, wherein the associated keypad character is one of 0, 1, 2, 3, 4, 5, 6, 7, 8, 9, * and #.

4. The method of claim 1, wherein the speech navigation system includes a wireless communication device.

5. The method of claim 1, wherein the wireless communication device is one of a mobile telephone and a cellular telephone.

6. The method of claim 1, wherein the voice mail system performs a function associated with the telephone dialing tone.

7. The method of claim 1, further including the step of:
transitioning to a speech recognition mode while maintaining the communication link between the speech navigation system and the voice mail system.

8. A speech navigation system for communicating with a voice mail system, the speech navigation system comprising:
a wireless communication device for establishing a communication link with the voice mail system;
a processor coupled to the wireless communication device;
a memory subsystem coupled to the processor, the memory subsystem storing a plurality of voice commands and a plurality of keypad characters, wherein at least one of the plurality of keypad characters are each associated with one of the plurality of voice commands; and
a voice input circuit coupled to the processor for receiving a voice command from a user, wherein the processor is configured to associate a received voice command with at least one of the plurality of keypad characters and cause the wireless communication device to provide a corresponding telephone dialing tone to the voice mail system via the communication link.

9. The system of claim 8, wherein the telephone dialing tone is a dual tone multiple frequency (DTMF) tone.

10. The system of claim 8, wherein the plurality of keypad characters include 0, 1, 2, 3, 4, 5, 6, 7, 8, 9, * and #.

11. The system of claim 8, wherein the wireless communication device is one of a mobile telephone and a cellular telephone.

12. The system of claim 8, wherein the voice mail system performs a function associated with the telephone dialing tone when received.

13. The system of claim 8, further including:
a switch coupled to the processor, wherein the speech navigation system transitions from a voice mode to a speech recognition mode while maintaining the communication link with the voice mail system upon activation of the switch and transitions back to the voice mode upon deactivation of the switch.

14. The system of claim 8, wherein the speech navigation system transitions from a voice mode to a speech recognition mode while maintaining the communication link with the voice mail system upon receiving a first predetermined voice command and transitions back to the voice mode upon receiving a second predetermined voice command.

15. The system of claim 14, wherein the first predetermined voice command and the second predetermined voice command are the same.

16. An automotive speech navigation system for communicating with a voice mail system, the speech navigation system comprising:
a wireless communication device located within a motor vehicle for establishing a communication link with the voice mail system;
a processor coupled to the wireless communication device;
a memory subsystem coupled to the processor, the memory subsystem storing a plurality of voice commands and a plurality of keypad characters, wherein at least one of the plurality of keypad characters are each associated with one of the plurality of voice commands; and
a voice input circuit coupled to the processor for receiving a voice command from a user, wherein the processor is configured to associate a received voice command with at least one of the plurality of keypad characters and cause the wireless communication device to provide a corresponding dual tone multiple frequency (DTMF) tone to the voice mail system via the communication link, and wherein the voice mail system performs a function associated with the DTMF tone when received.

17. The system of claim 16, wherein the plurality of keypad characters include 0, 1, 2, 3, 4, 5, 6, 7, 8, 9, * and #.

18. The system of claim 16, further including:
a switch coupled to the processor, wherein the speech navigation system transitions from a voice mode to a speech recognition mode while maintaining the communication link with the voice mail system upon activation of the switch and transitions back to the voice mode upon deactivation of the switch.

19. The system of claim 16, wherein the speech navigation system transitions from a voice mode to a speech recognition mode while maintaining the communication link with the voice mail system upon receiving a first predetermined voice command and transitions back to the voice mode upon receiving a second predetermined voice command.

20. The system of claim 19, wherein the first predetermined voice command and the second predetermined voice command are the same.

21. The system of claim 16, wherein the wireless communication device is one of a mobile telephone and a cellular telephone.
